(19) United States
(12) Patent Application Publication
(10) Pub. No.: US 2004/0134434 A1
(43) Pub. Date: Jul. 15, 2004

(54) Treat dispensing device with clicker for training animals

(76) Inventors: Michael D. Kraft, Abilene, KS (US); Theresa E. Kraft, Abilene, KS (US)

Correspondence Address: THOMPSON & THOMPSON, P.A., 310 4th Street, P.O. Box 66, Scandia, KS, 66966, US

(21) Appl. No.: 10/345,473

(22) Filed: Jan. 15, 2003

(51) Int. Cl. A01K 1/10; A01K 5/00; A01K 39/00

(52) U.S. Cl. 119/51.01

(57) ABSTRACT

A treat dispensing device includes a dispenser mechanism for dispensing individual treats, and a clicking mechanism associated with the dispenser mechanism for providing a clicking noise to signal and reward an animal each time the dispenser mechanism is operated to dispense a treat. The device includes a housing and a dispenser wheel rotatably connected to the housing. The dispenser wheel and housing define a plurality of compartments for holding individual treats. A bottom opening is provided in the housing through which individual treats can be loaded into the compartments and from which the treats can be dispensed. The clicking mechanism includes a structure which is biased into engagement with an inner surface of the dispenser wheel. The inner surface has a plurality of circumferentially spaced grooves corresponding in number to the compartments, so that a clicking noise is made each time the dispenser wheel is rotated to expose another compartment.

### BACKGROUND OF THE INVENTION

1. Field of the Invention

The present invention relates generally to animal training devices and treat dispensers. In particular, the present invention relates to a treat dispensing device with a built-in clicker mechanism for training animals.

2. Description of the Related Art

There are a number of techniques used in the prior art for training animals, such as dogs, cats, and other pets. Among these techniques are the use of pet treats, such to as dried meats, milk bones, candy and so forth, to reward the animal each time the animal exhibits a desired behavior. For example, an animal can be taught to lay down, roll over, fetch, open and close doors, and many other things by using a combination of voice commands, hand signals, pet treats, and sounds to stimulate the animal.

In the prior art, pet treats are often carried in the trainer's pocket or in a sealable plastic sandwich bag, or the like. Some products have also been specially developed to help trainers carry treats for the animals being trained. These products generally consist of a cloth bag equipped with a belt clip to attach to the trainer's belt and a drawstring or hook and pile (e.g., VELCRO™) closure system to open and close the bag. The pouch is generally made out of nylon cloth or leather and usually has a single opening in the top for loading the treats into the pouch and for taking them out.

Another technique for training pets has been the use of a “clicker” to reward the animal with a clicking noise when the animal exhibits a desired behavior. Clickers are usually made of a plastic housing with a metal plate that produces a loud clicking noise when depressed by the trainer's thumb or finger. Clickers are usually small handheld devices that can be carried in the trainer's pocket or attached to a key chain. The clicking noise produced by the clickers is a desired stimulus for the animal, and can be used effectively by a trainer to reward the animal. Some trainers use a combination of food treats and clicking noises to train animals.

The prior art also includes a variety of animal toys that include a treat dispensing feature and/or contact-activated sound and light features. Examples of such animal toys are shown in U.S. Pat. Nos. 6,484,671, 6,325,693, 6,237,538, and 4,414,921. These prior art animal toys are believed to be effective for their intended purpose, i.e., to encourage exercise and playful behavior by the targeted animals. However, these toys are not very useful in training animals to follow the commands of a human trainer.

There is a need in the industry for a treat dispensing device that offers a convenient way for an animal trainer to carry pet treats, and that also provides a sound stimulant to the animal as a further reward for desired behavior.

### SUMMARY OF THE INVENTION

An object of the present invention is to provide a treat dispensing device for training animals that dispenses individual treats and also provides a clicking noise to signal and reward an animal each time the dispenser mechanism is operated.

A further object of the present invention is to provide a treat dispensing device for training animals that is highly intuitive in operation, and that provides a highly effective training technique by combining the reward of an edible treat with the reward of an audible clicking noise.

It is a further object of the present invention to provide a treat dispensing device for training animals that is economical to manufacture, efficient and reliable in use, capable of a long operating life, and particularly well suited for use in training animals, such as dogs.

To accomplish these and other objects, an improved treat dispensing device for training animals is provided that uses both edible treats and audible clicking noises as rewards for good behavior. The device comprises a housing and a dispenser wheel rotatably connected to the housing. The dispenser wheel and housing cooperate together to define a plurality of compartments for holding individual treats. An opening is provided in the housing through which individual treats can be loaded into the compartments and from which the treats can be dispensed. A clicking mechanism is arranged between the dispenser wheel and the housing to provide a clicking noise to signal and reward an animal each time the dispenser wheel is rotated to dispense a treat.

According to another broad aspect of the present invention, a treat dispensing device for training animals is provided, comprising: a dispenser mechanism for dispensing individual treats; and a clicking mechanism associated with the dispenser mechanism for providing a clicking noise to signal and reward an animal each time the dispenser mechanism is operated to dispense a treat.

Numerous other objects and advantages of the present invention will be apparent to those skilled in this art from the following description wherein there is shown and described a preferred embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a perspective front view of a treat dispensing device having a clicker mechanism for training animals according to the present invention.

FIG. 2 is a cutaway perspective view of the treat dispensing device according the present invention.

FIG. 3 is a perspective rear view of the treat dispensing device according to the present invention.

FIG. 4 is a front view of the treat dispensing device according to the present invention.

FIG. 5 is a side view of the treat dispensing device according to the present invention.

FIG. 6 is a bottom view of the treat dispensing device according to the present invention.

FIG. 7 is a cross-section bottom view of the treat dispensing device, as viewed along line 7-7 in FIG. 4.

FIG. 8 is a cross-section side view of the treat dispensing device, as viewed along line 8-8 in FIG. 4.

FIG. 9 is a rear view of the treat dispensing device according to the present invention with hidden parts shown in dashed lines.

FIG. 10 is a front view of a housing of the treat dispensing device of the present invention.

FIG. 11 is a bottom view of the housing shown in FIG. 10.

FIG. 12 is a cross-section side view of the housing, as viewed along line 12-12 in FIG. 10.

FIG. 13 is a perspective front view of the housing shown in FIG. 10.

FIG. 14 is a perspective rear view of the housing shown in FIG. 10.

FIG. 15 is a front view of a dispenser wheel of the treat dispensing device of the present invention.

FIG. 16 is a cross-section view of the dispenser wheel, as viewed along line 16-16 in FIG. 15.

FIG. 17 is a side view of the dispenser wheel shown in FIG. 15.

FIG. 18 is a perspective front view of the dispenser wheel shown in FIG. 15.

FIG. 19 is a perspective rear view of the dispenser wheel shown in FIG. 15.

### DETAILED DESCRIPTION OF THE PREFERRED EMBODIMENT

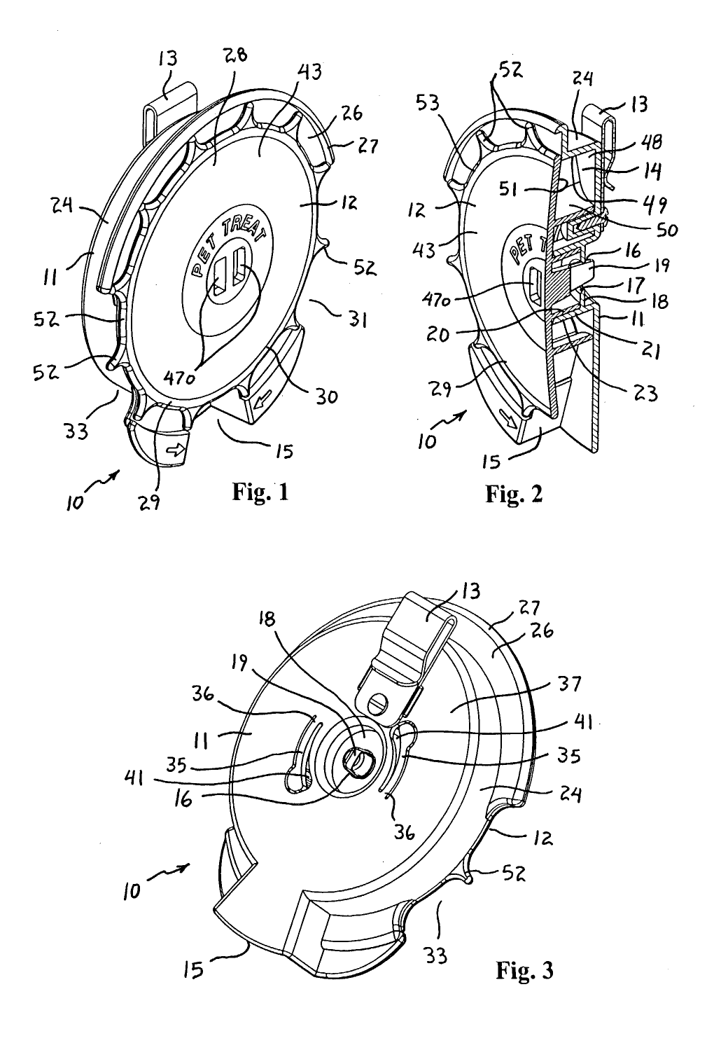

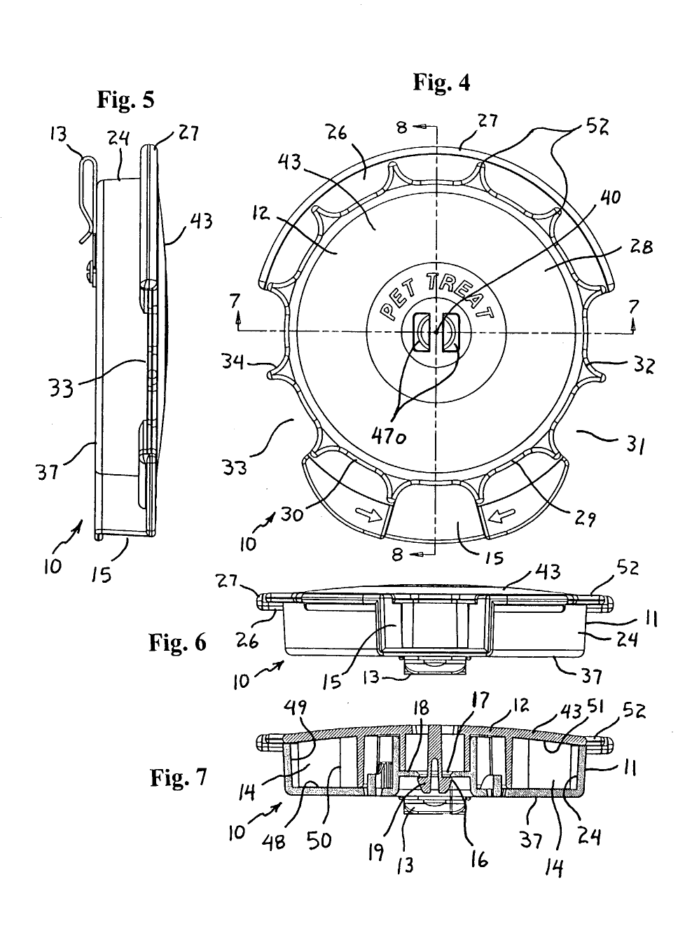

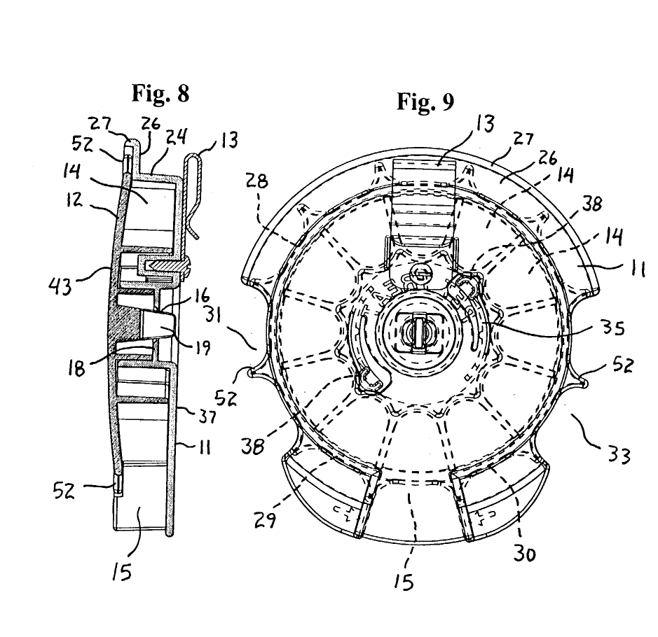

A treat dispensing device 10 according to a preferred embodiment of the present invention will now be described with reference to FIGS. 1 to 19 of the accompanying drawings.

The treat dispensing device 10 includes a housing 11, and a dispenser wheel 12 rotatably connected to the housing 11. A belt clip 13 is secured to a rear side of the housing 11 for attaching the device 10 to a user's belt (not shown) or other suitable item of apparel. The housing 11 and dispenser wheel 12 cooperate together to define a plurality of compartments 14 for holding individual treats (not shown). The dispenser wheel 12 can be rotated relative to the housing 11 to selectively dispense individual treats from an opening 15 defined in the bottom of the housing 11. The treats are loaded into the compartments 14 through the same opening 15 before the device 10 is attached to the user.

The dispenser wheel 12 and housing 11 are secured together by a snap-fit coupling 16. The snap-fit coupling 16 is provided by a receptacle 17 formed in a rear wall 18 of the housing 11, and a split barbed projection 19 extending from a middle of the dispenser wheel 12 along a center axis thereof. Alternatively, the receptacle can be provided on the dispenser wheel 12, and the barbed projection can be provided on the housing 11. A cylindrical bearing surface 20 is provided on the dispenser wheel 12 surrounding the barbed projection 19. A corresponding cylindrical bearing surface 21 protrudes from the rear wall 18 of the housing 11. The cylindrical bearing surfaces 20, 21 provide a smooth and stable rotation of the dispenser wheel 12 relative to the housing 11, particularly when these components are formed of materials having high natural lubricity.

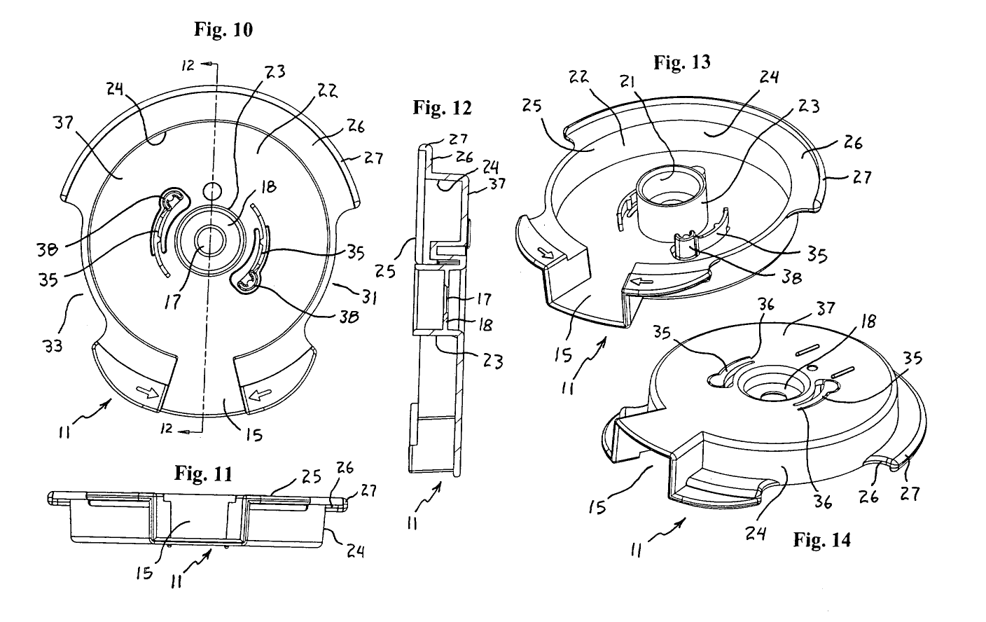

The structure of the housing 11 will be explained with reference to FIGS. 10 to 14. The housing 11 is preferably made by injection molding and has a generally donut-shaped interior 22 defined by an inner cylindrical wall 23, an outer cylindrical wall 24, and a rear wall 37 which extends between the inner and outer walls 23, 24. The housing 11 has an open front side 25 opposing the rear walls 18, 37. A protective flange 26 extends outwardly from a front edge of the outer wall 24, and a protective lip 27 extends in an axial direction from the flange 26. The flange 26 and lip 27 are arranged to partially conceal and protect approximately the upper half 28 of the dispenser wheel 12 and portions 29, 30 thereof on each side of the opening 15 in the bottom of the housing 11. A first discontinuity 31 is provided in the protective flange 26 and protective lip 27 to expose a first portion 32 of the dispenser wheel 12 to facilitate operation by a right-handed user, and a second discontinuity 33 is provided to expose a second portion 34 of the dispenser wheel 12 to facilitate operation by a left-handed user.

A pair of resilient arms 35 are provided in the rear wall 37 of the housing 11. The arms 35 each have a first end 36 secured to the rear wall 37 of the housing 11, for example, by integrally molding the arms 35 with the housing 11. A second free end of each of the arms 35 is preferably formed with a smooth, rounded surface as a modulator structure 38. The purpose of the modulator structure 38 is to enhance the clicking noise produced each time the dispenser wheel 12 is rotated, as explained below. The arms 35 function to resiliently bias the modulator structure 38 radially outwardly into engagement with the inner surface 39 of the dispenser wheel 12. The arms 35 are positioned on diametrically opposed sides of an axis of rotation 40 of the dispenser wheel 12. As a result, the force applied by one of the arms 35 to one side of the dispenser wheel 12 is balanced by the force applied by the other arm 35 to the other side of the dispenser wheel 12. Cutout portions 41 are provided in the rear wall 37 of the housing 11 to allow the arms 35 to flex in a radial direction during operation.

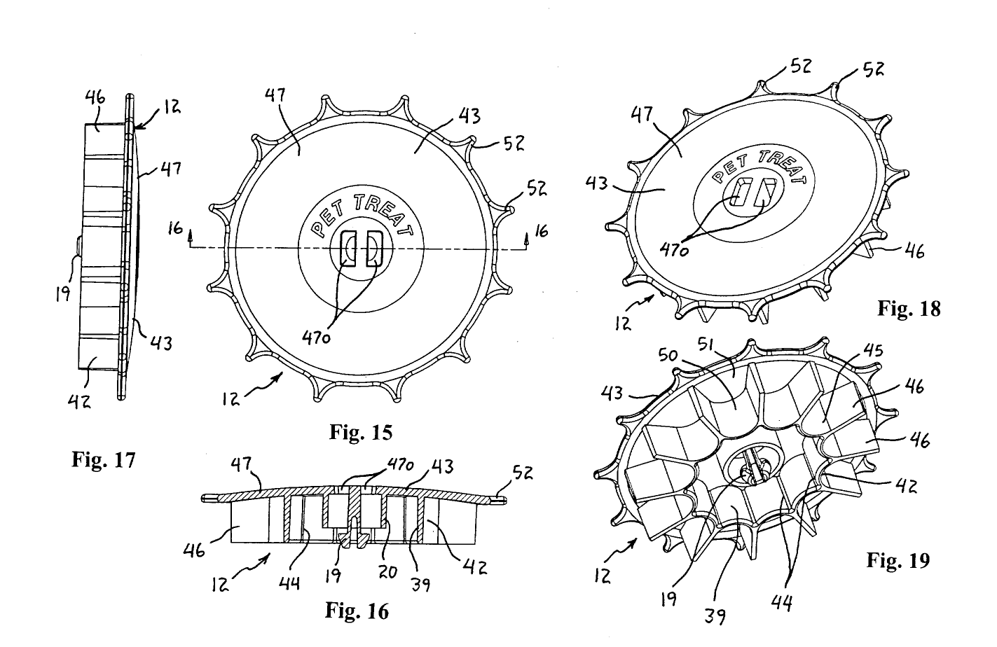

The structure of the dispenser wheel 12 will be explained with reference to FIGS. 15 to 19. The dispenser wheel 12 is preferably made by injection molding and has a first inner structure 42 and a second outer structure 43. The first inner structure 42 is received in the interior 22 of the housing 11. The first inner structure 42 has a fluted inner surface 39 comprising a plurality of surface undulations or grooves 44 that are engaged by the modulator structure 38 of the housing 11. The grooves 44 cooperate with the arms 35 and the modulator structure 38 of the housing 11 to provide the desired clicking noise. That is, each time the dispenser wheel 12 is rotated by a predetermined amount, a clicking noise is caused by the modulator structure 38 snapping into another groove 44. The first inner structure 42 of the dispenser wheel 12 further includes an outer surface 45 defined by a plurality of fins 46 extending radially outwardly from the first structure 42. The fins 46 provide partitions between the compartments 14.

The second outer structure 43 provides a front face 47 of the dispenser wheel 12 that extends across the open front side 25 of the housing 11. Two open ports 47o are formed in the front face 47 to let clicking sounds from the modulator structure 38 pass freely out of the housing 11. Each of the compartments 14 for housing individual treats has a rear side 48 defined by the rear wall 37 of the housing 11, an outer side 49 defined by the outer cylindrical wall 24 of the housing 11, U-shaped interior sides 50 defined by the fins 46, and a front side 51 defined by the front face 47 of the dispenser wheel 12.

The second outer structure 43 of the dispenser wheel 12 also has a plurality of projections 52 extending outwardly from an outer periphery 53 thereof. The projections 52 are engageable by a user's fingers to rotate the dispenser wheel 12 to activate the device 10. In the preferred embodiment, the projections 52 extending outwardly from the dispenser wheel 12 correspond in number and location to the fins 46 and the grooves 44 provided on the dispenser wheel 12. As a result, a highly intuitive arrangement is provided whereby a new projection 52 is exposed and moved to a central position in each of the first and second discontinuities 31, 33 to prepare the device 10 for the next operation each time the dispenser wheel 12 is advanced to empty one compartment 14 and provide the expected clicking noise.

In operation, the device 10 is first loaded with individual treats which are selected to reward an animal being trained. The treats are loaded into the device 10 by holding the device 10 generally upside down and rotating the dispenser wheel 12 as the treats are dropped into each of the compartments 14. Once the dispenser wheel 12 has been rotated one full turn, all of the compartments 14 will have been filled and should contain a treat. The device 10 is then clipped to the user's belt or other suitable item of apparel, such as a waist band or pocket of the user's pants. When clipped to the user, the device 10 is in an upright position and the dispenser wheel 12 will rotate about a generally horizontal axis 40. The opening 15 defined in the housing 11 is located at a bottom of the device 10 so that the dispensed treats fall through the opening 15 by gravitational force.

During animal training exercises, a treat can be dispensed from the device 10 by the user engaging one of the exposed projections 52 of the dispenser wheel 12 with the user's finger to rotate the dispenser wheel 12. In the case of a device 10 having twelve compartments 14, as shown in the drawings, the dispenser wheel 12 will be rotated 30 degrees (1/12 of a turn) for each treat.

Each time the dispenser wheel 12 is advanced to dispense a treat, the device 10 also provides a highly audible clicking noise through the ports 47o as a result of the modulating structure 38 engaging one of the grooves 44 on the inner side of the dispenser wheel 12. The clicking noise provides a highly effective reward for the animal's good behavior and also signals the animal that a treat has been dispensed. The modulating structure 38 also helps ensure that the dispenser wheel 12 is not inadvertently advanced more than one compartment 14 at a time, and also ensures that the next exposed projection 52 is centrally positioned for being activated by the user to dispense the next treat.

It will be appreciated that certain features of the present invention described above can be changed without departing from the scope of the invention. For example, the number of compartments 14 can be increased or decreased by changing the number of fins 46, projections 52, and grooves 44 on the dispenser wheel 12. Other suitable structures, such as snaps or hook-and-pile fastener strips, can be used to secure the device to the user or the user's apparel during operation. Other types of modulating structures can be used to provide the desired clicking noise, such as one or more steel balls each being biased by a compression spring into engagement with a corresponding groove on the fluted inner surface 39 of the dispenser wheel 12.

While the invention has been specifically described in connection with specific embodiments thereof, it is to be understood that this is by way of illustration and not of limitation, and the scope of the appended claims should be construed as broadly as the prior art will permit.

What is claimed is:

1. A treat dispensing device for training animals, comprising:
a housing;
a dispenser wheel rotatably connected to said housing, said dispenser wheel and housing cooperating together to define a plurality of compartments for holding individual treats;
an opening defined in said housing through which individual treats can be loaded into said plurality of compartments and from which said individual treats can be dispensed; and
a clicking mechanism arranged to provide a clicking noise to signal and reward an animal each time said dispenser wheel is rotated to dispense a treat.

2. The treat dispensing device according to claim 1, further comprising a belt clip secured to a rear side of said housing for attaching said device to a user's belt.

3. The treat dispensing device according to claim 1, wherein said housing has a generally donut-shaped interior defined by an inner cylindrical wall, an outer cylindrical wall, and a rear wall extending between said inner and outer walls, and said housing has an open front side opposing said rear wall.

4. The treat dispensing device according to claim 3, wherein said dispenser wheel has a first structure received in the interior of said housing, said first structure having a fluted inner surface that cooperates with said clicking mechanism to provide said clicking noise, said first structure further comprising an outer surface defined by a plurality of fins extending radially outwardly from said first structure which provide partitions between said compartments.

5. The treat dispensing device according to claim 4, wherein said dispenser wheel further comprises a second structure secured to said first structure and extending across the open front side of said housing, said second structure having a plurality of projections extending outwardly from an outer periphery thereof, said projections being engageable by a user's fingers to rotate the dispenser wheel to activate said clicking mechanism and dispense a treat from the device, said second structure further comprising at least one open port formed therein that allows clicking noises produced by said clicking mechanism to pass freely therethrough.

6. The treat dispensing device according to claim 5, wherein said housing has a protective flange extending outwardly from a front edge of said outer wall and a protective lip extending in an axial direction from said flange, said flange and lip being arranged to partially conceal and protect a first part of said projections extending from said dispenser wheel and to expose a second part of said projections.

7. The treat dispensing device according to claim 6, wherein a first discontinuity in said protective flange and said protective lip is provided to expose projections for a right-handed user, and a second discontinuity in said protective flange and said protective lip is provided to expose projections for a left-handed user.

8. The treat dispensing device according to claim 1, wherein said clicking mechanism comprises a modulator structure which is resiliently biased into engagement with a fluted inner surface of said dispenser wheel, whereby said modulator structure clicks against said fluted inner surface to provide said clicking noise upon rotation of said dispenser wheel.

9. The treat dispensing device according to claim 8, wherein said fluted inner surface comprises a plurality of grooves which are engaged by said modulator structure, said plurality of grooves corresponding in number to said plurality of compartments, whereby said clicking noise is provided each time the dispenser wheel is rotated to expose another compartment to said opening defined in said housing.

10. The treat dispensing device according to claim 9, wherein said modulator structure comprises a first arm having a first end secured to said housing and a second end biased into engagement with one of the grooves in said fluted inner surface of the dispenser wheel.

11. The treat dispensing device according to claim 10, wherein said modulator structure comprises a second arm positioned diametrically opposed to said first arm, said second arm having a first end secured to said housing and a second end biased into engagement with another one of the grooves in said fluted inner surface of the dispenser wheel so as to oppose a force applied by said first arm on said dispenser wheel.

12. The treat dispensing device according to claim 11, wherein said first and second arms are integrally formed with said housing, and said second ends of said first and second arms have a rounded engaging surface that clicks against the fluted inner surface of the dispenser wheel to cause the clicking noise produced by the device.

13. The treat dispensing device according to claim 1, wherein a snap-fit coupling is provided to rotatably secure said dispenser wheel to said housing.

14. The treat dispensing device according to claim 10, wherein said snap-fit coupling comprises a receptacle formed in one of said housing and said dispenser wheel, and a barbed projection extending from the other of said housing and said dispenser wheel, said barbed projection being snap-fitted into said receptacle to rotatably secure said dispenser wheel to said housing.

15. The treat dispensing device according to claim 1, wherein said housing and said dispenser wheel are formed by injection molding.

16. A treat dispensing device for training animals, comprising:
a housing;
a dispenser wheel rotatably coupled to said housing, said dispenser wheel and housing cooperating together to define a plurality of compartments for holding individual treats;
an opening defined in said housing through which individual treats can be loaded into said plurality of compartments and from which said individual treats can be dispensed; and
a clicking mechanism comprising a modulating structure which is resiliently biased into engagement with a surface containing a plurality of undulations, whereby said modulating structure clicks against said surface to provide a clicking noise each time the dispenser wheel is rotated to dispense a treat.

17. The treat dispensing device according to claim 16, wherein said surface containing a plurality of undulations is a fluted inner surface of the dispenser wheel which comprises a plurality of grooves which are engaged by said modulating structure, said plurality of grooves corresponding in number to said plurality of compartments.

18. The treat dispensing device according to claim 17, wherein said modulating structure is supported by a free end of a resilient arm secured to said housing, said resilient arm being arranged to bias said modulating structure radially outwardly into engagement with the fluted inner surface of the dispenser wheel.

19. The treat dispensing device according to claim 16, further comprising a means for supporting the device in an upright position during use such that said dispenser wheel rotates about a generally horizontal axis, and said opening defined in the housing is located at a bottom of the device, whereby the dispensed treats fall through the opening by gravitational force.

20. A treat dispensing device for training animals, comprising:
a dispenser mechanism for dispensing individual treats; and
a clicking mechanism associated with said dispenser mechanism for providing a clicking noise to signal an animal each time the dispenser mechanism is operated to dispense a treat.
